(19) United States
(12) Patent Application Publication
(10) Pub. No.: US 2007/0195082 A1
(43) Pub. Date: Aug. 23, 2007

(54) Three-dimensional processing device, information terminal, computer program, and three-dimensional processing method

(75) Inventors: Nobuaki Takanashi, Tokyo (JP); Kazuhide Yoshinaga, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignees: NEC CORPORATION, Tokyo (JP); NEC LCD TECHNOLOGIES, LTD., Kawasaki-shi (JP)

(21) Appl. No.: 11/699,053

(22) Filed: Jan. 29, 2007

(30) Foreign Application Priority Data
Jan. 30, 2006 (JP) 2006-20877

(51) Int. Cl. G06T 15/00

(52) U.S. Cl. 345/419

(57) ABSTRACT

A three-dimensional processing device (100) includes a table (180), a table reading unit (120), and a parallax image generator (130). The table reading unit (120) reads an object string (110) as input to display in a screen, reads from the table (180) depth position information and shape additional information for objects by using object types as keys, and outputs to the parallax image generator (130) the objects after adding the read information as three-dimensional parameters. The parallax image generator (130) generates and outputs parallax images (190) based on the input object information and designation information of three-dimensional parameters.

This application claims priority to prior Japanese patent application JP 2006-20877, the disclosure of which is incorporated herein by reference.

### BACKGROUND OF THE INVENTION

The present invention relates to a three-dimensional processing device generating parallax images from a plurality of view points for displaying a three-dimensional image by combination of the parallax images, and a three-dimensional information terminal displaying three-dimensional information. The present invention is for example applicable to information terminals such as game devices, equipment instruction manual display terminals, and cellular phones.

Supported by recent progress in the computer graphics field and remarkable improvement in processing capability of CPUs (Central Processing Units), attempts have been started to display three-dimensional video images on personal computers, portable game machines, and cellular phones. Some such products are already on the market. For effective display of three-dimensional video images, it is required to newly generate three-dimensional video image contents. Actually, however, there are still many cases in which contents data formed of two-dimensional texts and/or two-dimensional images produced for conventional two-dimensional information terminals are processed by three-dimensional display devices. Therefore, there have been proposed various three-dimensional information terminals designed to be switchable between three-dimensional display and two-dimensional display.

Japanese Laid-Open Patent Publication No. 2004-133305 titled “Electronic Device Having 2D (two-dimensional) and 3D (three-dimensional) Display Functions” describes an example of conventional information terminals. This information terminal is switchable between two-dimensional and three-dimensional display functions by being provided with key input means for switching to three-dimensional image display.

This information terminal is also designed to be able to transmit pictograms and images in addition to and simultaneously with text data as electronic mails, and to thereby increase the usability and amusing effects of electronic mails. The fun of e-mail message exchange and the value of the information communication terminals are particularly enhanced if three-dimensional images or texts and pictograms represented three-dimensionally can be transmitted.

Japanese Laid-Open Patent Publication No. 2004-234614 titled “Electronic Message Transmission/Reception System Using Portable Terminal and Portable Terminal Used in Electronic Transmission/Reception System” describes a second example of conventional information terminals. This information terminal makes it possible to exchange three-dimensional images as an e-mail, by preliminarily storing pictograms to be displayed three-dimensionally and transmitting/receiving an e-mail having designation information stored in its header.

Japanese Laid-Open Patent Publication No. 2004-362553 tilted “Communication Terminal Device, Correspondence Data Display Method, Correspondence Data Display Program, and Information Recording Medium Recording Such Program” describes a third example of conventional information terminals. Despite of not being intended to exchange three-dimensional images, this information terminal is able to display character images such as animation without transmitting or receiving special designation information when exchanging plain text e-mail messages. Specifically, the information terminal extracts a key word from conventional text data and, when the key word matches, implements control on the display mode of character images preliminarily recorded in association with the key word. In this manner, the information terminal is capable of displaying character images such as animation even for an electronic mail formed by text data only.

However, the prior arts described above have following problems.

The first problem is that, as for conventional three-dimensional information terminals having a function to switch between two-dimensional and three-dimensional display modes, the display is possible only when two-dimensional or three-dimensional images to be displayed are registered in the terminal. When data is exchanged with other three-dimensional information terminals via e-mails or the like, the data exchange is possible only with the terminals using the same data format.

The second problem is that, even as for three-dimensional information terminals capable of exchanging three-dimensional images as an e-mail by transmitting/receiving the e-mail having designation information stored in the header, the exchange of three-dimensional images is possible only between the terminals using the same data format.

The third problem, common to both of the first and second conventional three-dimensional information terminals, is that when a three-dimensional image is transmitted by the three-dimensional information terminal, the received data cannot be displayed at all by conventional terminals only having a two-dimensional display function.

The fourth problem is that, as for a conventional communication terminal device designed to display, when exchanging a text e-mail, character images such as animation by means of keywords contained in the e-mail without transmission or reception of special designation information, such communication terminal device is able to display a few character images corresponding to the keywords on the entire screen, but no consideration is made for adding animation or three-dimensional effect to the text and pictograms in the e-mail.

The present invention has been made in view of the problems as described above. It is an object of the present invention to provide an attractive three-dimensional processing device and three-dimensional information terminal having a function to effectively three-dimensionalize and display contents consisting of conventional two-dimensional texts and/or two-dimensional pictograms, and capable of exchanging information while maintaining compatibility with conventional information terminals only having a two-dimensional display function.

### SUMMARY OF THE INVENTION

According to a first aspect of the present invention, a three-dimensional processing device for generating parallax images from a plurality of view points for displaying a three-dimensional image by combination of the parallax images, by changing, for a plurality of objects in a screen, the display positions of the objects in the respective parallax images according to depth positions of the objects, the three-dimensional processing device comprising: a table for holding at least depth position information of the objects by using object types as keys; and a reading unit for reading the table, the parallax images being produced by selecting and applying the information held in the table for each of the objects is provided.

According to a second aspect of the present invention, the information held in the table includes the depth position information as first information and shape additional information as second information.

According to a third aspect of the present invention, the information held in the table includes time-varying information of the first information and/or the second information.

The term “object” as used herein refers to each rendering unit such as an image, a character, and a pictogram to be arranged in a display screen. Same objects can be assigned with an ID, or an object type, so that a plurality of objects belonging to the same type in the screen can be displayed with the same display effect. This display effect shall be herein referred to as the “three-dimensional effect”. In addition to a depth position, the three-dimensional effect parameters registered in a table may include shape additional information, namely an enlargement ratio, inclination, brightness, hue, chroma, and other modification parameters, so that the registered three-dimensional effect parameters are applied when generating a screen display. Objects on a plurality of parallax images are shifted from their initial positions in accordance with the depth positions set for the respective object types, whereby the depth positions perceived three-dimensionally can be moved. Further, a three-dimensional processing device capable of generating three-dimensional images including effective three-dimensional animation can be obtained by changing the above-mentioned three-dimensional effect parameters in terms of time for a two-dimensional still screen having a plurality of objects arranged in the screen.

According to a fourth aspect of the present invention, the table is rewritable.

According to a fifth aspect of the present invention, the three dimensional processing device further includes a communication module for performing data transmission via data network to another communication device, wherein the table is updated in accordance with the data transmission.

According to a sixth aspect of the present invention, the three-dimensional processing device further includes an interface for connecting to a storage device different from the storage storing the table, wherein the table is updated on the basis of the data stored in the different storage.

According to a seventh aspect of the present invention, the three-dimensional processing device according to the second aspect includes: a data identification module receiving an object string as an input data string and identifying, from the input data string, data matching with object types held in the table; and a data conversion module which, based on the identification result of the data identification module, directly outputs data in the input data string held in the table, and outputs data held in the table after rewriting the depth position information as the first information and/or the shape additional information as the second information according to contents held in the table.

According to a eighth aspect of the present invention, the object types include a text data string and attributes thereof, and a pictogram data string and character attribute thereof, the parallax images being generated after generating two-dimensional text shape images based on the object types.

According to a ninth aspect of the present invention, an information terminal for displaying information generated by another terminal, including: a three-dimensional processing device according to Claim 8; and a three-dimensional display device displaying a three-dimensional image by combination of a plurality of parallax images from a plurality of view points, the information terminal receiving, as input, text data and attributes thereof, and/or pictogram data and attributes thereof is provided.

According to a tenth aspect of the present invention, the three-dimensional display device of the information terminal of the ninth aspect is able to display the three-dimensional image together with a two-dimensional image.

According to a eleventh aspect of the present invention, the information terminal according to the ninth aspect includes an input unit for inputting information to be transmitted to another terminal, the input unit having a text display menu screen for displaying, during data input, a list of two-dimensional texts and two-dimensional pictograms together with the objects held in the table to enable the selective entry from the list, the objects held in the table being displayed while being subjected to the three-dimensional processing.

According to a twelfth aspect of the present invention, the information terminal according to the ninth aspect transmits to another terminal a text data string and attributes thereof, and a pictogram data string and attributes thereof as object types.

According to a thirteenth aspect of the present invention, the information terminal according to the ninth aspect includes a display unit for displaying the contents of the table, and an editing and inputting unit for editing and inputting the contents of the table.

According to a fourteenth aspect of the present invention, the information terminal according to the ninth aspect further includes a communication module for performing data transmission via data network to another communication device, wherein the table is updated in accordance with the data transmission.

According to a fifteenth aspect of the present invention, the information terminal according to the ninth aspect further includes an interface for connecting to a storage device different from the storage storing the table, wherein the table is updated on the basis of the data stored in the different storage.

According to a sixteenth aspect of the present invention, the contents of the table are exchangeable between the information terminal and other terminals by the use of information exchange means.

According to the first aspect of the present invention, parallax images from a plurality of view points are generated by changing, for a plurality of objects in a screen, the display positions of the objects in the parallax images according to depth positions of the objects. This provides a three-dimensional processing device capable of effectively generating a three-dimensional image by combination of these parallax images.

According to the second to seventh aspects of the present invention, a three-dimensional processing device can be obtained which is able to effectively generate a three-dimensional image with animation in a two-dimensional still screen having a plurality of objects arranged therein. This makes it possible to effectively utilize two-dimensional still image contents created by conventional techniques as three-dimensional animation images. The three-dimensional parameters can be rewritten as required. This makes it possible to realize either different or identical three-dimensional effect among a plurality of three-dimensional processing devices according to the present invention. According to the eighth aspect of the invention, a three-dimensional animation image can be generated from any conventionally created text.

According to the ninth and tenth aspects of the invention, a three-dimensional information terminal can be obtained which is able to effectively display e-mail messages and texts received from conventional information terminals only having a two-dimensional display function, as three-dimensional animation images. According to the eleventh aspect of the invention, a text such as an e-mail message including three-dimensional animation images can be created with simple operation while checking the three-dimensional effect according to the present invention. Further, according to the twelfth aspect of the invention, it is possible to not only provide an image such as an e-mail having a three-dimensional animation effect to other three-dimensional information terminals according to the present invention, but also provide an e-mail message or the like that can be read by a conventional information terminal only having a two-dimensional display function. Thus, an excellent effect can be achieved that a three-dimensional information terminal solving the problem of compatibility with two-dimensional information terminals can be obtained.

According to the thirteenth aspect of the invention, the contents of the table designating the three-dimensional effect parameters can be rewritten or edited on the terminal. Therefore, a three-dimensional effect customized to reflect personal tastes of the user can be realized. According to the fourteenth and fifteenth aspects of the invention, it is possible to realize an e-mail message to exchange three-dimensional information by using communication means, and an instruction manual with a three-dimensional effect that is distributed by means of a storage medium. According to the sixteenth aspect of the invention, it is made possible to exchange a table designating the three-dimensional effect parameters with another three-dimensional information terminal to apply the customized three-dimensional effect on the terminal.

According to a seventeenth aspect of the present invention, a computer program for causing a computer to implement three-dimensional processing for generating parallax images from a plurality of view points for displaying a three-dimensional image by combination of the parallax images, by changing, for a plurality of objects in a screen, the display positions of the objects in the respective parallax images according to depth positions of the objects, the three-dimensional processing including: processing to store in a table at least depth position information for the objects while using object types as keys; and processing to generate the parallax images by selecting and applying information stored in the table for each of the objects is provided.

According to a eighteenth aspect of the present invention, a three-dimensional processing method for generating parallax images from a plurality of view points for displaying a three-dimensional image by combination of the parallax images, by changing, for a plurality of objects in a screen, the display positions of the objects in the respective parallax images according to depth positions of the objects is provided. The three-dimensional processing method includes the steps of: storing in a table at least depth position information for the objects while using object types as keys; and generating the parallax images by selecting and applying information stored in the table for each of the objects.

According to nineteenth aspect of the present invention, a three-dimensional processing device for generating a set of parallax images for stereogram, at least one object being drawn in each of the parallax images, comprising: a storage for storing a table which relates types of objects with depths of the objects and; at least one processor for retrieving a depth from the table corresponding to an object to be drawn in a set of parallax images, calculating each position of the object in each of the parallax images on the basis of the retrieved depth, and generating the parallax images in which the object is drawn at the calculated position is provided.

According to a twentieth aspect of the present invention, a method of generating a set of parallax images for stereogram, at least one object being drawn in each of the parallax images, comprising the steps of: storing to a storage a table which relates types of objects with depths of the objects; retrieving, by a processor, a depth from the table corresponding to an object to be drawn in a set of parallax images; calculating, by a processor, each position of the object in each of the parallax images on the basis of the retrieved depth; and generating by a processor, the parallax images in which the object is drawn at the calculated position is provided.

According to a twenty-first aspect of the present invention, a computer program for generating a set of parallax images for stereogram, at least one object being drawn in each of the parallax images, comprising the steps of: storing to a storage a table which relates types of objects with depths of the objects; retrieving a depth from the table corresponding to an object to be drawn in a set of parallax images; calculating each position of the object in each of the parallax images on the basis of the retrieved depth; and generating the parallax images in which the object is drawn at the calculated position is provided.

### BRIEF DESCRIPTION OF THE DRAWING

FIG. 1 is a block diagram showing a three-dimensional processing device according to a first embodiment of the present invention;

FIG. 2 is a sketch drawing for explaining principles and operation of a parallax image generator realizing a three-dimensional effect;

FIG. 3 is a flowchart showing procedures of processing implemented by the parallax image generator;

FIG. 4 is a block diagram showing a three-dimensional processing device according to a second embodiment of the present invention;

FIG. 5 is a block diagram showing a three-dimensional processing device according to a third embodiment of the present invention;

FIG. 6 is a block diagram showing a three-dimensional processing device according to a fourth embodiment of the present invention;

FIG. 7 is a block diagram showing a three-dimensional processing device according to a fifth embodiment of the present invention;

FIG. 8 is a block diagram showing a three-dimensional processing device according to a sixth embodiment of the present invention;

FIG. 9 is a block diagram showing a three-dimensional processing device according to a seventh embodiment of the present invention;

FIG. 10 is a diagram showing a data entry screen according a ninth embodiment of the present invention;

FIG. 11 is a block diagram showing a three-dimensional information terminal according to a tenth embodiment of the present invention;

FIG. 12 is a block diagram showing a three-dimensional information terminal according to an eleventh embodiment of the present invention;

FIG. 13 is a block diagram showing a three-dimensional information terminal according to a twelfth embodiment of the present invention;

FIG. 14 is a block diagram showing an example in which the present invention is applied to a game machine;

FIG. 15 is a block diagram showing an example of an e-mail function portion of a cellular phone having a three-dimensional processing device according to the present invention applied thereto; and

FIG. 16 is a diagram showing an example of an e-mail display by a cellular phone having the present invention applied thereto.

### DESCRIPTION OF THE PREFERRED EMBODIMENTS

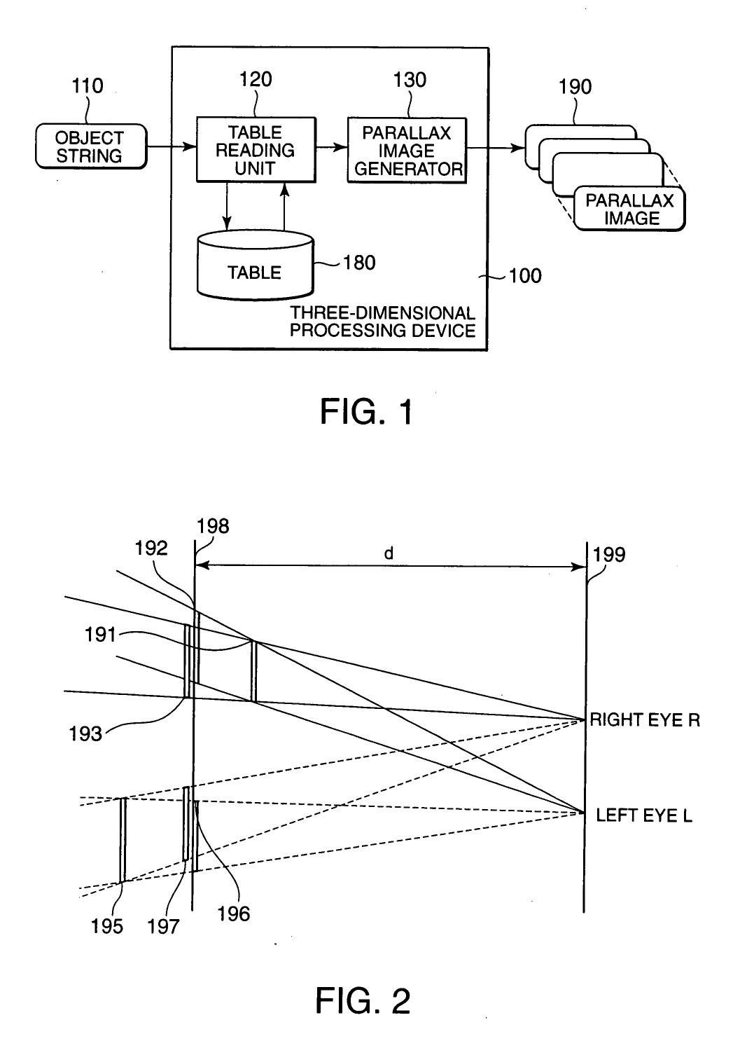

Preferred embodiments of the present invention will be described specifically with reference to the accompanying drawings. FIG. 1 a block diagram showing a three-dimensional processing device according to a first embodiment of the present invention. As shown in FIG. 1, the first embodiment of the present invention is composed of a table 180, a table reading unit 120, and a parallax image generator 130.

These component modules operate as schematically described below. Objects displayed in a screen are assigned with IDs as object types representing types of the objects. The table 180 holds depth position information as first information for the respective objects using the object types as keys. The table 180 may additionally hold shape additional information for display effects as second information. The term “objects” as used herein refers to rendering units such as images, characters, and pictograms arranged in a display screen. Same objects can be assigned with an ID, or an object type, so that a plurality of objects belonging to the same type in the screen can be displayed with the same display effect. This display effect shall be referred to herein as the “three-dimensional effect”. The three-dimensional effect parameters registered in the table 180 may include, in addition to a depth position, an enlargement ratio, inclination, brightness, hue, chroma, and other modification parameters as shape additional information. The information held by the table 180 may include time-varied information of the first information and/or the second information.

Table 1 is a table showing an example of information registered in the table 180. The items of depth position and shape additional information are associated with the object types. The table reading unit 120 reads a plurality of object strings 110 displayed in the screen as input. The table reading unit 120 reads, from the table 180, depth position information as the first information and shape additional information as the second information of an object using the object type as a key, and outputs to the parallax image generator 130 the result of adding the read information to the entered object information as the three-dimensional effect.

TABLE 1

| | | Shape Additional |
|---|---|---|
| Object Type | Depth Position | Information |
| . . . | . . . | . . . |
| . . . | . . . | . . . |

Based on the entered object information and the designation information of the three-dimensional effect, the parallax image generator 130 three-dimensionally processes the plurality of objects in the screen by varying the display positions of the objects in a parallax image according to the depth positions of the respective objects to generate parallax images from a plurality of view points, and outputs the parallax images thus generated. Thus, a three-dimensional processing device can be obtained which is capable of generating a three-dimensional image having effective three-dimensional animation by further varying, in terms of time, the three-dimensional effect on a two-dimensional still screen having a plurality of objects arranged in the screen.

FIG. 2 is a sketch drawing for explaining principles and operation for realizing the three-dimensional effect by the parallax image generator 130. In this drawing, objects are observed at an observation point 199 located at a distance d from a display, and an object A191 close to the observation point and an object B195 far from the observation point are observed. It is assumed as an example that there is a screen 198 between the objects. The object A191 observed by a left eye L at the observation point 199 is projected on the screen at a position of a projected image 192, while the object A191 observed by a right eye R is projected on the screen at a position of a projected image 193. Similarly, the object B195 observed by the left eye L at the observation point 199 is projected on the screen at a position of a projected image 196 and the object B195 observed by the right eye R is projected on the screen at a position of a projected image 197. Assuming the screen 198 to be a three-dimensional display, an object image is drawn at the positions of the projected image 192 and the projected image 196 on a left-eye parallax image screen, while drawn at the position of the projected image 193 and the projected image 197 on a right-eye parallax image screen, so that the object image is displayed in a three-dimensional fashion. In this manner, the observer is caused to perceive as if the object is present at a desired depth position. Specifically, the parallax image generator 130 is able to generate parallax images as desired by the operation described below. In the case of a multiple view point three-dimensional display system in which three or more parallax images are used instead of only two left and right parallax images, a required number of parallax images 190 may be generated by implementing the above-described projection processing for the number of times corresponding to the number of the required images.

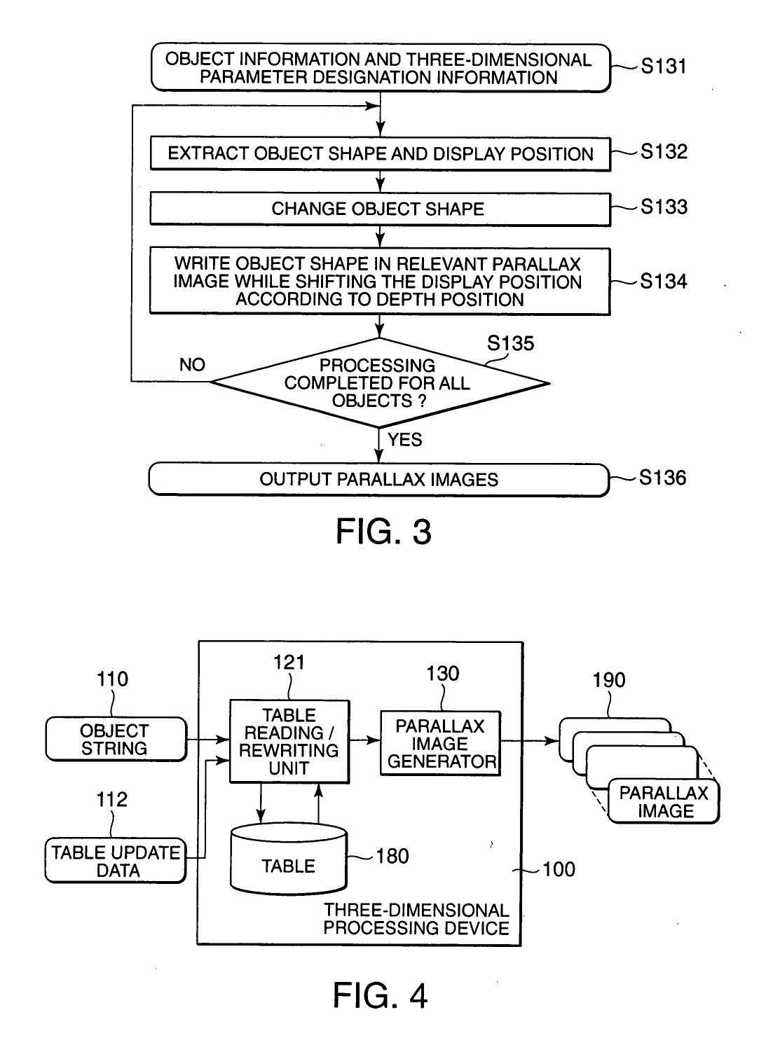

Procedures of processing implemented by the parallax image generator 130 will be described with reference to the flowchart of FIG. 3. The parallax image generator 130 receives input of object information and three-dimensional effect designation information (S131). The object information includes object shapes and basic display positions on the screen, which are extracted in this step (S132). Subsequently, each object is subjected to the modification according to shape additional information based on the three-dimensional effect designation information (S133). Subsequently, in order to realize the three-dimensional effect according to the depth position information, the display position of each object is shifted from its initial position and written in the relevant parallax image (S134). It is determined whether all the objects have been subjected to the processing described above (S135) and, if not, the steps from S132 to S134 are repeated. If the processing for all the objects has been completed, the parallax images are output (S136).

Effects of this embodiment will be described. According to this embodiment, a plurality of parallax images can be generated for each of a plurality of objects arranged in a two-dimensional still screen, by designating depth position information as the first information and shape additional information as the second information. Accordingly, two-dimensional still image contents produced by a conventional technique can be utilized effectively as three-dimensional animation images.

A three-dimensional processing device according to a second embodiment of the present invention will be described with reference to FIG. 4. As shown in FIG. 4, the second embodiment of the present invention is composed of a table 180, a table reading/rewriting unit 121, and a parallax image generator 130. The second embodiment is characterized in that the table 180 is rewritable. The table reading/rewriting unit 121 performs the same reading operation as the first embodiment during implementation of the three-dimensional processing, but rewrites the table 180 upon receiving table update data 112.

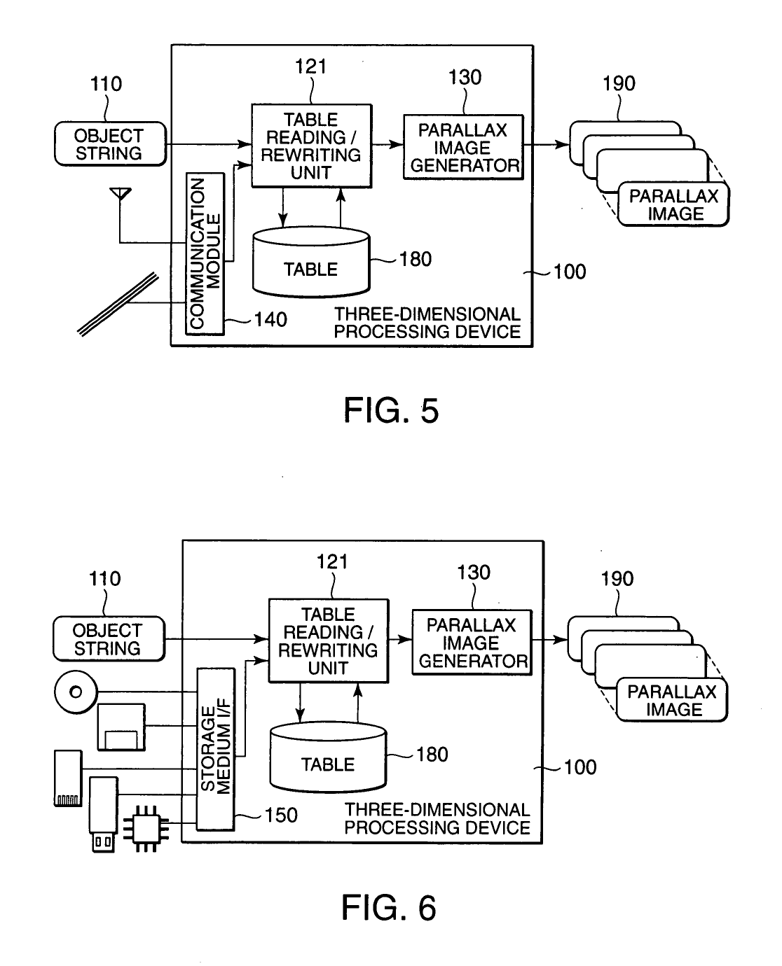

A three-dimensional processing device according to a third embodiment of the present invention will be described with reference to FIG. 5. As shown in FIG. 5, the third embodiment of the present invention is composed of a table 180, a table reading/rewriting unit 121, a parallax image generator 130, and a communication module 140. The third embodiment is characterized in that the table is updated in accordance with data communication which is performed with the communication module 140 via wired and/or wireless networks to another terminal or a server.

A three-dimensional processing device according to a fourth embodiment of the present invention will be described with reference to FIG. 6. As shown in FIG. 6, the fourth embodiment of the present invention is composed of a table 180, a table reading/rewriting unit 121, a parallax image generator 130, and a storage medium I/F 150. The fourth embodiment is characterized in that the three-dimensional processing device is composed of the storage medium I/F 150 for connecting a storage device different from the storage device storing the table 180, and the table 180 is updated on the basis of data stored in the different storage device. The storage medium may be any storage medium that is available when the three-dimensional processing device is embodied according to the present invention. Further, the configuration of the fourth embodiment can be combined with the configuration of the third embodiment of the present invention in which the table is updated in accordance with data communication which is performed with the communication module 140 via wired and/or wireless networks to another terminal or a server.

According to the second to fourth embodiments of the present invention, the three-dimensional effect parameters can be rewritten as required. It is therefore made possible for a plurality of three-dimensional processing devices according to the present invention to realize mutually different three-dimensional effects or an identical three-dimensional effect.

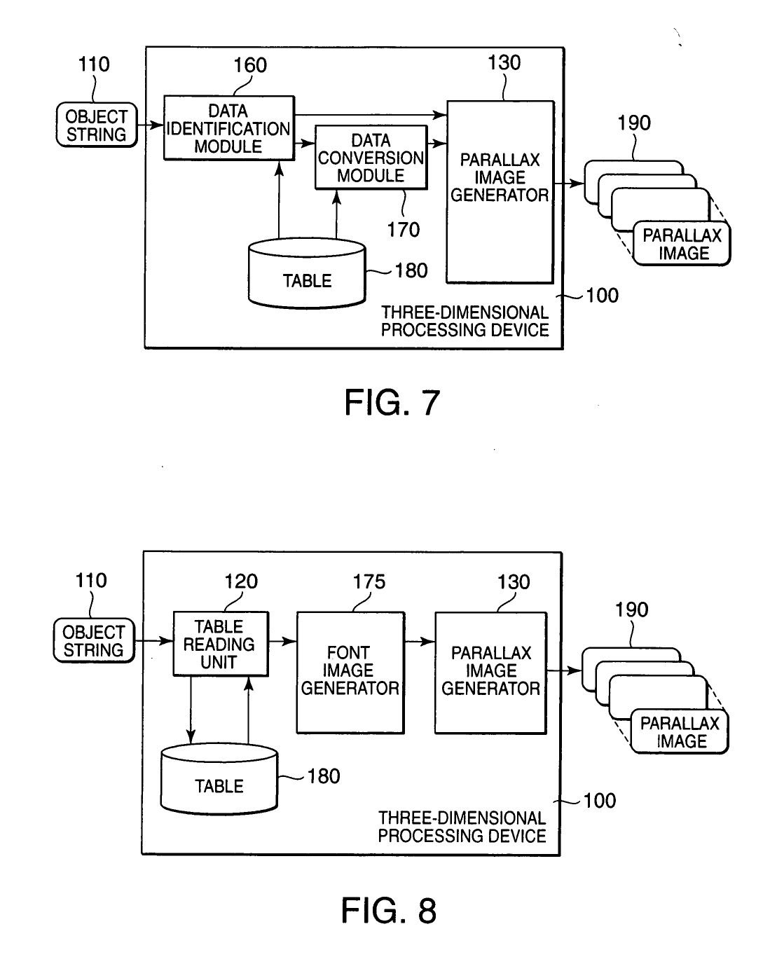

A three-dimensional processing device according to a fifth embodiment of the present invention will be described with reference to FIG. 7. As shown in FIG. 7, the fifth embodiment of the present invention is composed of a table 180, a data identification module 160, a data conversion module 170, and a parallax image generator 130. The three-dimensional processing device of the fifth embodiment may be combined with any of the second to fourth embodiments or any desired combination thereof and may be configured so that the table 180 is updated.

These modules operate as schematically described below. The data identification module 160 compares the combination of object types included in the object string 110 with the object types described in the table 180. Any data in the object string 110 not registered in the table 180 is directly output to the parallax image generator 130. Object data registered in the table is output to the data conversion module 170.

The data conversion module 170 rewrites the depth position and/or shape additional information of the received object data according to the registered particulars described in the table 180 to output the resulting data to the parallax image generator 130.

Effects of the fifth embodiment will be described. According to the fifth embodiment, objects not registered in the table are displayed in the same manner as by a conventional terminal only having a two-dimensional display function, whereas objects having object types registered in the table are three-dimensionally displayed with the registered three-dimensional effect parameters. Accordingly, the embodiment has an advantage that a three-dimensional processing device can be obtained which is able to perform the three-dimensional processing while keeping the compatibility with conventional two-dimensional objects.

A three-dimensional processing device according to a sixth embodiment of the present invention will be described with reference to FIG. 8. As shown in FIG. 8, the sixth embodiment of the present invention is composed of a table 180, a table reading unit 120, a font image generator 175, and a parallax image generator 130. The three-dimensional processing device of the sixth embodiment may be combined with any of the second to fifth embodiments or any desired combination thereof and may be configured so that the table 180 is updated or the processing can be performed on an object string that is not registered in the table.

The sixth embodiment of the present invention as a whole operates as schematically described below. The sixth embodiment is characterized in that an input object string 110 is formed by a text data string and attributes thereof, and/or a pictogram data string and attributes thereof. The object types are the input text data string and attributes thereof, and the pictogram data string and attributes thereof. Therefore, the text code or the pictogram code describing the object is input to the font image generator 175 together with the corresponding text attributes, and output to the parallax image generator 130 as two-dimensional text shape images by the use of font information corresponding to the characters or pictograms. At the same time, the depth position and shape additional information for realizing the three-dimensional effect corresponding to the object output by the table reading unit 120 are also output to the parallax image generator 130. According to the sixth embodiment of the present invention, three-dimensional animation images can be generated from any conventional text.

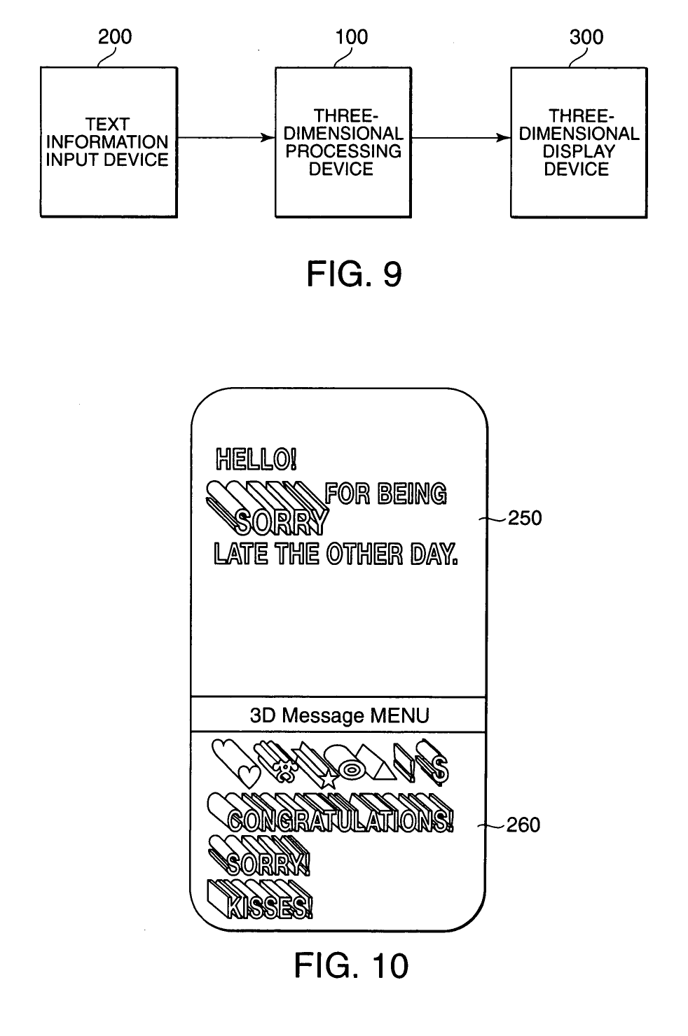

A three-dimensional information terminal according to a seventh embodiment of the present invention will be described with reference to FIG. 9. As shown in FIG. 9, the seventh embodiment of the present invention is composed of a text information input device 200, a three-dimensional processing device 100 receiving a text data string and attributes thereof, and/or a pictogram data string and attributes thereof, a three-dimensional display device 300 displaying a three-dimensional image by combining plurality of parallax images from a plurality of view points. The text information input device 200 can be embodied by using any means, such as wired or wireless communication means or a storage medium, as long as it has a function to receive information generated by other terminals. Further, a three-dimensional information terminal according to the eighth embodiment of the present invention may be embodied by the three-dimensional display device 300 which is designed to be able to display mixing of two-dimensional images and three-dimensional images. In this case, an even higher effect can be obtained.

The three-dimensional display device 300 includes an optical system for transmitting parallax images to each eye. Such optical systems are disclosed in Japanese Laid-Open Patent Publication No. 2004-133305. In one of the optical systems a parallax barrier is applied to produce parallax.

According to the seventh and eighth embodiments of the present invention, a three-dimensional information terminal can be obtained which is able to display a message formed of conventional two-dimensional texts and/or two-dimensional pictograms generated by other terminals, as an effective three-dimensional animation.

A specific example of a three-dimensional information terminal having the three-dimensional processing device 100 according to the seventh or eighth embodiment of the present invention applied thereto. FIG. 14 shows an example in which the three-dimensional processing device according to the present invention is applied to a game machine using game contents based on conventional two-dimensional images.

As shown in FIG. 14, the game machine includes an operation switch 500, a computation controller 600, a stripe image memory 700, a three-dimensional processing device 100, and a three-dimensional display device 300. A game machine based on a two-dimensional screen holds screen components, or rendering units such as game characters and background as layers or stripe images, and displays them at desired positions on the display screen after moving or modifying them according to a storyline or development in a game. This configuration makes it possible to move the components such as game characters and background on the screen or to change the game scene from a daytime scene to a nighttime scene, for example, by simple operation and a small amount of computation.

The game machine is designed such that the computation controller 600 renders an object on the stripe image memory 700 while setting a display position for the object according to development in the game by the operation switch 500. Each object is assigned with an ID as an object type before being input to the three-dimensional processing device 100, whereby the three-dimensional processing is performed on the objects registered in the table of the three-dimensional processing device 100. Thus, an effective three-dimensional animation can be obtained.

Table 2 shows an example of particulars of description in the table incorporated in the three-dimensional processing device according to this example. Object IDs are entered under the item “Object Type”. Although, in Table 2, object names are used as the object types for the convenience of description, the object types may be numeric values that are easy for computers or electronic circuits to handle.

TABLE 2

| Object Type | Depth Position | Shape Additional Information |
|---|---|---|
| Background 1 | −100 | Still |
| Background 2 | −40 | Still |
| Game Character A | +20 | Enlargement/Reduction 20% |
| Game Character B | +50 | Rotation ±15 degrees, |
| | | Brightness ±15% |
| . . . | . . . | . . . |

Numeric values may be entered under the item “Depth Position” in units according to the screen size. For example, a positive value indicates that the object is to be displayed in front of a two-dimensional image not registered in the table, whereas a negative value indicates that the object is to be displayed in the back thereof. The magnitudes of the values indicate the magnitudes of distances in the depth direction. In this example, it is designated that the background 1 and the background 2 are displayed in the back and the game characters A and B are displayed in front. The shape additional information may include temporal variation in addition to the change in shapes and colors. In the example shown in Table 2, the game character A is displayed in front of the position of the two-dimensional screen while being 20% enlarged or reduced with respect to its size on the stripe image memory. The game character B is displayed in the same shape as on the stripe image memory in further front of the game character A while being swung from side to side by 15 degrees and while changing its brightness by 15%.

As described above, the configuration of this example makes it possible to play a game with three-dimensional video images by using conventional 2D-based game contents, and makes it possible to improve the game development efficiency. Further, when the three-dimensional processing device is embodied by hardware, an excellent effect can be obtained that the computation load to the computation controller can be reduced while realizing the three-dimensional display.

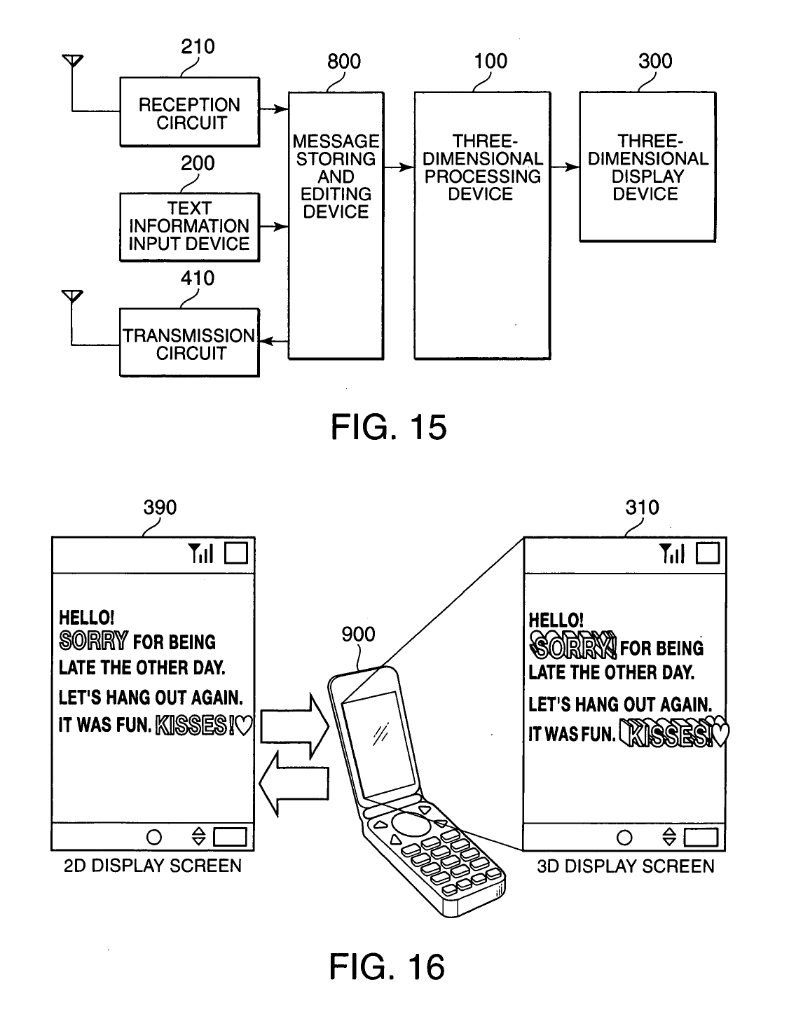

FIG. 15 shows an example of an e-mail function portion of a cellular phone as a specific example in which the three-dimensional processing device 100 of the seventh or eighth embodiment of the present invention is applied. The cellular phone in this example includes a reception circuit 210, a text information input device 200, a transmission circuit 410, a message storing and editing device 800, a three-dimensional processing device 100, and a three-dimensional display device 300.

The components operate as schematically described below. The reception circuit 210 receives an e-mail message and various control information forming the e-mail. The text information input device 200 is formed of a plurality of push button switches, and is used for entering or editing a message in an e-mail and operating the cellular phone. The transmission circuit 410 transmits e-mail messages and various control methods. The message storing and editing device 800 extracts an e-mail message from received data and records the same. The message storing and editing device 800 also implements the entry and editing of an e-mail message according to instruction given by the operation of the text information input device, and if necessary outputs a received message or a message being created or edited to the three-dimensional processing device 100. Receiving the message, the three-dimensional processing device 100 implements the three-dimensional processing according to the present invention. The three-dimensional display device 300 displays the message that has been subjected to the three-dimensional processing with a three-dimensional effect.

Table 3 below shows an example of description in the table 180 in the three-dimensional processing device. Objects to be handled in this example are two-dimensional texts and attributes thereof. Therefore, for example, text strings and attributes such as a color are registered as object types. The three-dimensional effect parameters registered in the table include, for example, that a string of red-colored letters forming a word “Sorry” is displayed 72 pt in front of a stationary two-dimensional text to which no three-dimensional effect is applied. A red-colored heart (pictogram) is displayed by moving the same back and forth by ±20% from the position 72 pt in front of the two-dimensional text to which no three-dimensional effect is applied.

FIG. 16 shows an example of e-mail message display by a cellular phone to which this example is applied. When a two-dimensional e-mail message as shown in a two-dimensional display screen 390 is transmitted from a conventional cellular phone only having a two-dimensional display function to a cellular phone 900 according to the present invention, the three-dimensional processing is implemented according to Table 3 by the function of the three-dimensional processing device of the present invention so that the e-mail message is displayed with a three-dimensional effect as shown in a three-dimensional display screen 310. When an e-mail message having a three-dimensional effect as shown in FIG. 16 is transmitted to a conventional cellular phone only having the two-dimensional display function, only the text code and attributes such as colors of the two-dimensional text forming the e-mail message are transmitted. Therefore, the e-mail message is displayed as an ordinary two-dimensional e-mail message as shown in a two-dimensional display screen 390.

TABLE 3

| Object Type | Depth Position | Shape Additional Information |
|---|---|---|
| “Sorry”, Red | +72 pt | Still |
| “Sorry”, Blue | −72 pt | Rotated by ±15 degrees, |
| | | Brightness ±15% |
| “Kisses”, Red | +144 pt | Still |
| Heart (pictogram), | +72 pt | Back and forth by 20% |
| Red | | |

FIG. 10 is a diagram illustrating a data entry screen of a three-dimensional information terminal according to a ninth embodiment of the present invention. The entry screen is composed of a message entry portion 250 and a three-dimensional message menu portion 260. There are displayed, in the message entry portion 250, ordinary two-dimensional texts and two-dimensional pictograms together with texts with a three-dimensional effect. There is displayed, in the three-dimensional message menu portion 260, a list of the objects registered in the above-described table with the three-dimensional processing being applied thereto. The text information input device 200 (not shown) is operated to select and enter a message having the three-dimensional effect, whereby a text such as an e-mail message including a three-dimensional animation image can be created by a simple operation while checking the three-dimensional effect according to the present invention.

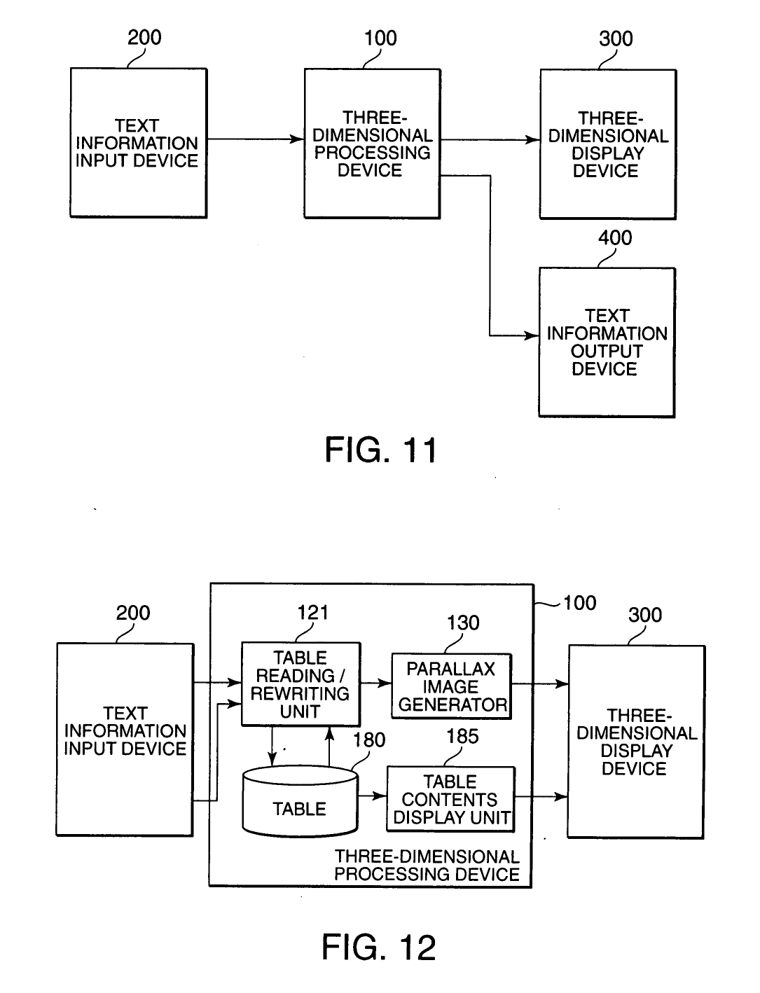

As shown in FIG. 11, a three-dimensional information terminal according to a tenth embodiment of the present invention includes a text information input device 200, a three-dimensional processing device 100 receiving a text data string and attributes thereof and/or a pictogram data string and attributes thereof, a three-dimensional display device 300 displaying a three-dimensional image by combining a plurality of parallax images from a plurality of view points, and a character information output device 400 outputting the text data string and the attributes thereof and/or the pictogram data string and attributes thereof.

In the tenth embodiment of the present invention, three-dimensional information held on the terminal is displayed with a three-dimensional effect and, additionally, is rendered exchangeable with other terminals by outputting the three-dimensional information to other terminals. However, it is provided that the object types output to other terminals are limited to two-dimensional texts or a text data string corresponding to a two-dimensional image and attributes thereof, and a pictogram data string and attributes thereof.

According to the tenth embodiment of the present invention, e-mail images or the like having a three-dimensional animation effect can be provided to other three-dimensional information terminals according to the present invention and, additionally, e-mail messages that can be read by a conventional information terminal only having a two-dimensional display function can also be provided thereto. Thus, the tenth embodiment provides an excellent effect that a three-dimensional information terminal solving the problem of compatibility with two-dimensional information terminals can be realized.

A three-dimensional information terminal according to an eleventh embodiment of the present invention will be described with reference to FIG. 12. As shown in FIG. 12, the eleventh embodiment of the present invention is formed by any or any combination of the seventh to tenth embodiments of the present invention, and includes a text information input device 200, a three-dimensional processing device 100 receiving a text data string and attributes thereof and/or a pictogram data string and attributes thereof, and a three-dimensional display device 300 displaying a three-dimensional image by combining a plurality of parallax images from a plurality of view points. In particular, the three-dimensional processing device 100 includes a table 180, a table reading/rewriting unit 121, a parallax image generator 130, and a table contents display unit 185.

The eleventh embodiment of the present invention makes it possible to perform editing operation, on a three-dimensional information terminal according to the present invention, to designate a content registered in the table 180 by operation of the text information input device 200 so as to display the designated content on the three-dimensional display device 300 via the table contents display unit 185, or to change the contents in the table 180. Therefore, it is made possible to realize a three-dimensional effect that is customized to reflect personal tastes of the user.

A three-dimensional information terminal according a twelfth embodiment of the present invention is characterized in that the text information input device 200 shown in FIG. 11 is formed by wired or wireless communication means.

A three-dimensional information terminal according to a thirteenth embodiment of the present invention is characterized in that the text information input device 200 shown in FIG. 11 is formed by a storage medium. The communication means of the twelfth embodiment may be additionally employed in the three-dimensional information terminal according to the thirteenth embodiment of the present invention.

According to the twelfth and thirteenth embodiments of the present invention, it is made possible to realize an e-mail message capable of exchanging three-dimensional information by the communication means, and instruction manuals with a three-dimensional effect that are distributed by using a storage medium.

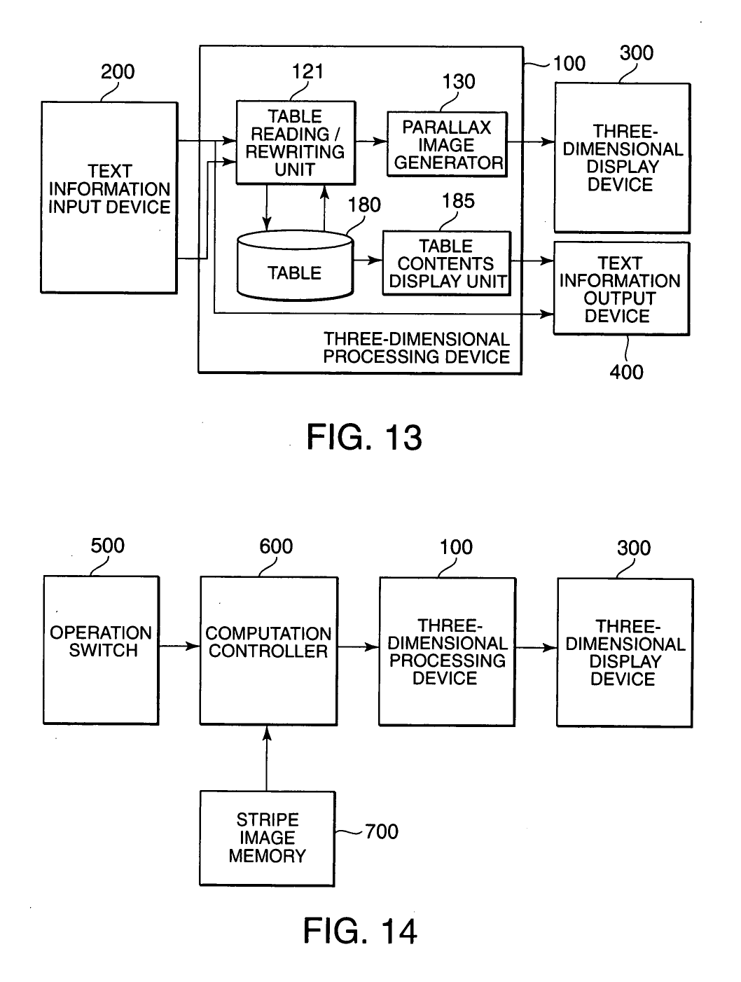

As shown in FIG. 13, a three-dimensional information terminal according to a fourteenth embodiment of the present invention is composed of a text information input device 200, a three-dimensional processing device 100 receiving a text data string and attribute thereof and/or a pictogram data string and attributes thereof, a three-dimensional display device 300 displaying a three-dimensional image by combining a plurality of parallax images from a plurality of view points, and a character information output device 400. The three-dimensional processing device 100 in particular includes a table 180, a table reading/rewriting unit 121, a parallax image generator 130, and a table contents display unit 185.

In the fourteenth embodiment of the present invention, the text information output device 400 is designed not only to output a message created by the text information input device 200 on an information terminal according to the present invention to another terminal, but also to output the contents in the table 180 read by the table contents display unit 185 to another terminal.

According to the fourteenth embodiment of the present invention, the table designating a three-dimensional effect can be exchanged with another three-dimensional information terminal to realize the customized three-dimensional effect on that terminal.

What is claimed is:

1. A three-dimensional processing device for generating parallax images from a plurality of view points for displaying a three-dimensional image by combination of the parallax images, by changing, for a plurality of objects in a screen, the display positions of the objects in the respective parallax images according to depth positions of the objects, the three-dimensional processing device comprising:
a table for holding at least depth position information of the objects by using object types as keys; and
a reading unit for reading the table,
the parallax images being produced by selecting and applying the information held in the table for each of the objects.

2. The three-dimensional processing device according to claim 1, wherein the information held in the table includes the depth position information as first information and shape additional information as second information.

3. The three-dimensional processing device according to claim 2, wherein the information held in the table includes time-varying information of the first information and/or the second information.

4. The three-dimensional processing device according to claim 1, wherein the table is rewritable.

5. The three-dimensional processing device according to claim 4, further comprising a communication module for performing data transmission via data network to another communication device, wherein the table is updated in accordance with the data transmission.

6. The three-dimensional processing device according to claim 4, further comprising an interface for connecting to a storage device different from the storage storing the table, wherein the table is updated on the basis of the data stored in the different storage.

7. The three-dimensional processing device according to claim 2, comprising:
a data identification module receiving an object string as an input data string and identifying, from the input data string, data matching with object types held in the table; and
a data conversion module which, based on the identification result of the data identification module, directly outputs data in the input data string held in the table, and outputs data held in the table after rewriting the depth position information as the first information and/or the shape additional information as the second information according to contents held in the table.

8. The three-dimensional processing device according to claim 1, wherein the object types include a text data string and attributes thereof, and a pictogram data string and character attribute thereof, the parallax images being generated after generating two-dimensional text shape images based on the object types.

9. An information terminal for displaying information generated by another terminal, comprising:
a three-dimensional processing device according to claim 8; and
a three-dimensional display device displaying a three-dimensional image by combination of a plurality of parallax images from a plurality of view points,
the information terminal receiving, as input, text data and attributes thereof, and/or pictogram data and attributes thereof.

10. The information terminal according to claim 9, wherein the three-dimensional display device is able to display the three-dimensional image together with a two-dimensional image.

11. The information terminal according to claim 9, comprising an input unit for inputting information to be transmitted to another terminal, the input unit having a text display menu screen for displaying, during data input, a list of two-dimensional texts and two-dimensional pictograms together with the objects held in the table to enable the selective entry from the list, the objects held in the table being displayed while being subjected to the three-dimensional processing.

12. The information terminal according to claim 9, wherein object types to be transmitted to another terminal are a text data string and attributes thereof, and a pictogram data string and attributes thereof.

13. The information terminal according to claim 9, comprising a display unit for displaying the contents of the table, and an editing and inputting unit for editing and inputting the contents of the table.

14. The information terminal according to claim 9, further comprising a communication module for performing data transmission via data network to another communication device, wherein the table is updated in accordance with the data transmission.

15. The information terminal according to claim 9, further comprising an interface for connecting to a storage device different from the storage storing the table, wherein the table is updated on the basis of the data stored in the different storage.

16. The information terminal according to claim 9, wherein the contents of the table are exchangeable with other terminals by the use of information exchange means.

17. A computer program for causing a computer to implement three-dimensional processing for generating parallax images from a plurality of view points for displaying a three-dimensional image by combination of the parallax images, by changing, for a plurality of objects in a screen, the display positions of the objects in the respective parallax images according to depth positions of the objects, the three-dimensional processing comprising:
processing to store in a table at least depth position information for the objects while using object types as keys; and
processing to generate the parallax images by selecting and applying information stored in the table for each of the objects.

18. A three-dimensional processing method for generating parallax images from a plurality of view points for displaying a three-dimensional image by combination of the parallax images, by changing, for a plurality of objects in a screen, the display positions of the objects in the respective parallax images according to depth positions of the objects, the three-dimensional processing method comprising the steps of:
storing in a table at least depth position information for the objects while using object types as keys; and
generating the parallax images by selecting and applying information stored in the table for each of the objects.

19. A three-dimensional processing device for generating a set of parallax images for stereogram, at least one object being drawn in each of the parallax images, comprising:
a storage for storing a table which relates types of objects with depths of the objects and;
at least one processor for retrieving a depth from the table corresponding to an object to be drawn in a set of parallax images, calculating each position of the object in each of the parallax images on the basis of the retrieved depth, and generating the parallax images in which the object is drawn at the calculated position.

20. A method of generating a set of parallax images for stereogram, at least one object being drawn in each of the parallax images, comprising the steps of:
storing to a storage a table which relates types of objects with depths of the objects;
retrieving, by a processor, a depth from the table corresponding to an object to be drawn in a set of parallax images;
calculating, by a processor, each position of the object in each of the parallax images on the basis of the retrieved depth; and
generating, by a processor, the parallax images in which the object is drawn at the calculated position.

21. A computer program for generating a set of parallax images for stereogram, at least one object being drawn in each of the parallax images, comprising the steps of:
storing to a storage a table which relates types of objects with depths of the objects;
retrieving a depth from the table corresponding to an object to be drawn in a set of parallax images;
calculating each position of the object in each of the parallax images on the basis of the retrieved depth; and
generating the parallax images in which the object is drawn at the calculated position.
